(19) United States
(12) Patent Application Publication
(10) Pub. No.: US 2014/0151609 A1
(43) Pub. Date: Jun. 5, 2014

(54) SLURRY COMPOSITION FOR COMPOSITE PARTICLES FOR POSITIVE ELECTRODE AND METHOD FOR PRODUCING COMPOSITE PARTICLES FOR POSITIVE ELECTRODE

(71) Applicant: Zeon Corporation, Tokyo (JP)

(72) Inventor: Hiroki OGURO, Tokyo (JP)

(73) Assignee: Zeon Corporation, Tokyo (JP)

(21) Appl. No.: 14/096,231

(22) Filed: Dec. 4, 2013

(30) Foreign Application Priority Data
Dec. 5, 2012 (JP) 2012-266747
Nov. 19, 2013 (JP) 2013-239282

(51) Int. Cl. H01M 4/62

(52) U.S. Cl. CPC H01M 4/622
USPC 252/506

(57) ABSTRACT

A slurry composition for composite particles for a positive electrode includes a positive electrode active material, a conductive material, a water soluble resin including a monomeric unit containing an acidic functional group, and a granular binder resin. The moisture content is at most 25% by mass, and the viscosity at a shear velocity of 10 s⁻¹ is at most 2000 mPa·s. A method for producing composite particles for a positive electrode of an electrochemical element includes kneading a mixture including a positive electrode active material, a conductive material, and a water soluble resin including a monomeric unit containing an acidic functional group, preparing a slurry composition with a moisture content of at most 25% by mass and a viscosity at a shear velocity of 10 s⁻¹ of at most 2000 mPa·s by adding a granular binder resin and water to the kneaded mixture, and spray drying the slurry composition.

### CROSS-REFERENCE TO RELATED APPLICATION

This application claims priority to and the benefit of Japanese Patent Application No. 2012-266747 filed Dec. 5, 2012 and Japanese Patent Application No. 2013-239282 filed Nov. 19, 2013, the entire contents of which are incorporated herein by reference.

### TECHNICAL FIELD

The present invention relates to a slurry composition suitably used in production of composite particles for a positive electrode used as the positive electrode of an electrochemical element, and to a method for producing the composite particles for a positive electrode.

### BACKGROUND ART

Electrochemical elements such as a lithium ion secondary battery and an electric double layer capacitor have the characteristics of being small, lightweight, and high in energy density, and they can be repeatedly charged and discharged. These electrochemical elements are therefore widely used.

An electrode used in an electrochemical element is generally formed by layering, on a collector, an electrode active material layer (also referred to as an “electrode mixed material layer”) formed by binding electrode active material with a binding agent. As the method for forming the electrode active material layer on the collector, a method has been proposed to transform a slurry composition that contains electrode active material and a binding agent into composite particles by spray drying the slurry composition, and to pressure form the resulting composite particles into an electrode active material layer (for example, see JP2008251776A (PTL 1)).

### CITATION LIST

### Patent Literature

PTL 1: JP2008251776A

### SUMMARY OF INVENTION

### Technical Problem

There is a demand for producing an electrochemical element electrode efficiently while guaranteeing the electrical characteristics of the electrode. Therefore, in the production of an electrochemical element electrode using the above composite particles, there is demand for efficient production of composite particles, i.e. for an improvement in the productivity of the composite particles.

One way of enhancing the productivity of the composite particles is to increase the solid content concentration of the slurry composition, thereby shortening the amount of time required for spray drying. Upon increasing the solid content concentration of the slurry composition, however, the viscosity of the slurry composition increases, making it difficult to perform dry granulation using spray drying. Therefore, it might not be possible to produce composite particles with desired properties (such as electrical characteristics).

Demand therefore exists for a slurry composition that can yield composite particles with desired properties by dry granulation using spray drying even when the solid content concentration is high, and for a high-productivity method for producing the composite particles.

### Solution to Problem

The inventor engaged in intensive research to solve the above problems. In a slurry composition used in production of composite particles for a positive electrode used in formation of the positive electrode of an electrochemical element, a conductive material is blended in order to offset the low conductivity of the positive electrode active material, and upon examination, the inventor newly discovered that, as a result, when the solid content concentration of the slurry composition is increased, not only does the problem of a rise in viscosity occur, but also the dispersiveness of the conductive material worsens, leading to the problem of not being able to obtain a positive electrode with desired electrical characteristics upon forming the positive electrode using composite particles prepared from the slurry composition. Upon further research, the inventor achieved the present invention by discovering that preparing an aqueous slurry composition with a predetermined viscosity by blending, through predetermined steps, a positive electrode active material, a conductive material, a granular binder resin as a binding agent, and a predetermined water soluble resin suppresses a large increase in viscosity and suppresses deterioration of the dispersiveness of the conductive material even when the solid content concentration is increased, allowing for production of composite particles for a positive electrode with desired electrical characteristics.

It is an object of the present invention to solve the above problems advantageously by providing a slurry composition for composite particles for a positive electrode that includes a positive electrode active material, a conductive material, a water soluble resin including a monomeric unit containing an acidic functional group, and a granular binder resin, a moisture content being at most 25% by mass, and a viscosity at a shear velocity of 10 s⁻¹ being at most 2000 mPa·s. By setting the moisture content to be at most 25% by mass, the amount of time required to produce the composite particles by spray drying the slurry composition can be shortened. Furthermore, by adding a water soluble resin including a monomeric unit containing an acidic functional group, the dispersiveness of the slurry composition can be enhanced, and an increase in the viscosity of the slurry composition due to an increase in the solid content concentration (i.e. a decrease in the moisture content) can be suppressed. Finally, setting the viscosity at a shear velocity of 10 s⁻¹ to be at most 2000 mPa·s allows for the efficient production of composite particles with good electrical characteristics by dry granulation using spray drying.

Note that in the present disclosure, the “moisture content of the slurry composition” can be determined by loss on drying. Specifically, when 2 g of the slurry composition is dried for 1 hour in a drier at a temperature of 105° C., the “moisture content of the slurry composition” indicates the ratio of the amount of evaporated moisture (i.e. the mass difference between before and after drying) to the mass of the slurry composition before drying (2 g). Furthermore, in the present disclosure, the “viscosity of the slurry composition at a shear velocity of 10 s⁻¹” indicates the viscosity measured at a temperature of 25° C. using a double cylinder rotary viscometer.

In the slurry composition for composite particles for a positive electrode according to the present invention, the positive electrode active material is preferably a Li₂MnO₃—LiNiO₂ based solid solution positive electrode active material. Using a Li₂MnO₃—LiNiO₂ based solid solution positive electrode active material as the positive electrode active material sufficiently increases the capacity of an electrochemical element having a positive electrode formed using the composite particles for a positive electrode obtained with the slurry composition and improves the electrical characteristics of the electrochemical element.

In the slurry composition for composite particles for a positive electrode according to the present invention, the water soluble resin including a monomeric unit containing an acidic functional group preferably includes at least one selected from the group consisting of a monomeric unit containing a sulfonic acid group, a monomeric unit containing a carboxyl group, and a monomeric unit containing a phosphoric acid group. By thus using a water soluble resin that includes a monomeric unit containing at least one selected from the group consisting of a monomeric unit containing a sulfonic acid group, a monomeric unit containing a carboxyl group, and a monomeric unit containing a phosphoric acid group, corrosion of the collector when the composite particles for a positive electrode prepared with the slurry composition are used in a positive electrode can be suppressed.

In the slurry composition for composite particles for a positive electrode according to the present invention, the granular binder resin preferably includes a monomeric unit of (meth)acrylic acid ester with a carbon number of 6 to 15, an α,β-unsaturated nitrile monomeric unit, and a monomeric unit containing a carboxyl group. By the granular binder resin thus including a monomeric unit of (meth)acrylic acid ester with a carbon number of 6 to 15, an α,β-unsaturated nitrile monomeric unit, and a monomeric unit containing a carboxyl group, good ion conductivity is obtained and battery life can be extended when the composite particles for a positive electrode prepared with the slurry composition are used in a positive electrode. Additionally, the granular binder resin has excellent preservation stability, mechanical strength, and binding properties.

In the slurry composition for composite particles for a positive electrode according to the present invention, the granular binder resin preferably includes a monomeric unit of dibasic acid. By the granular binder resin thus including a monomeric unit of dibasic acid, good ion conductivity is obtained and battery life can be extended when the composite particles for a positive electrode prepared using the slurry composition are used in a positive electrode. Additionally, the granular binder resin has excellent preservation stability, mechanical strength, and binding properties.

It is another object of the present invention to solve the above problems advantageously by providing a method for producing composite particles for a positive electrode that includes: kneading a mixture including a positive electrode active material, a conductive material, and a water soluble resin including a monomeric unit containing an acidic functional group to obtain a kneaded mixture; preparing a slurry composition with a moisture content of at most 25% by mass and a viscosity at a shear velocity of 10 s⁻¹ of at most 2000 mPa·s by adding a granular binder resin and water to the kneaded mixture; and spray drying the slurry composition to obtain composite particles. By setting the moisture content of the slurry composition to be at most 25% by mass, the amount of time required to produce the composite particles by spray drying the slurry composition can be shortened. Furthermore, by adding a water soluble resin including a monomeric unit containing an acidic functional group, the dispersiveness of the slurry composition can be enhanced, and an increase in the viscosity of the slurry composition due to an increase in the solid content concentration (i.e. a decrease in the moisture content) can be suppressed. Finally, adding a granular binder resin and water to the kneaded mixture of the positive electrode active material, the conductive material, and the water soluble resin including a monomeric unit containing an acidic functional group and setting the viscosity at a shear velocity of 10 s⁻¹ to be at most 2000 mPa·s allow for the production of composite particles with desired electrical characteristics by dry granulation using spray drying.

During the kneading step of the method for producing composite particles for a positive electrode according to the present invention, the mixture is preferably kneaded by applying an energy of 50 MJ/m³ to 200 MJ/m³. Kneading by applying an energy of 50 MJ/m³ to 200 MJ/m³ to the mixture disperses the conductive material well and sufficiently improves the electrical characteristics of a positive electrode formed using the composite particles.

### Advantageous Effect of Invention

The slurry composition according to the present invention allows for the production of composite particles for a positive electrode with desired electrical characteristics by dry granulation using spray drying even when the solid content concentration is high and improves the productivity of the composite particles for a positive electrode.

The method for producing composite particles for a positive electrode according to the present invention also improves the productivity of the composite particles for a positive electrode.

### DESCRIPTION OF EMBODIMENTS

The following describes embodiments of the present invention in detail.

The slurry composition for composite particles for a positive electrode according to the present invention are used to produce composite particles for a positive electrode used when forming the positive electrode of an electrochemical element such as a lithium ion secondary battery or an electric double layer capacitor. The method for producing composite particles for a positive electrode according to the present invention can be used when preparing the slurry composition for composite particles for a positive electrode according to the present invention and producing the composite particles for a positive electrode from the slurry composition.

Note that the composite particles for a positive electrode produced with the method for producing composite particles for a positive electrode according to the present invention using the slurry composition for composite particles for a positive electrode according to the present invention are used when forming a positive electrode active material layer positioned on the collector of a positive electrode. Formation of the positive electrode active material layer using the composite particles for a positive electrode is not particularly limited and may be performed using a known formation method, such as pressure formation or the like.

### <Slurry Composition for Composite Particles for Positive Electrode>

The slurry composition for composite particles for a positive electrode according to the present invention is an aqueous slurry composition and includes a positive electrode active material, a conductive material, a water soluble resin including a monomeric unit containing an acidic functional group, and a granular binder resin. The moisture content of the slurry composition is at most 25% by mass, and the viscosity of the slurry composition at a shear velocity of 10 s⁻¹ is at most 2000 mPa·s.

### <<Positive Electrode Active Material>>

The positive electrode active material blended into the slurry composition is not particularly limited, and a known positive electrode active material may be used. Examples of the positive electrode active material include a compound containing Ni as a transition metal, such as a lithium-nickel oxide (LiNiO₂), a lithium composite oxide of Co—Ni—Mn, a lithium composite oxide of Ni—Mn—Al, a lithium composite oxide of Ni—Co—Al, and a Li₂MnO₃—LiNiO₂ based solid solution; a lithium-containing composite metal oxide such as LiCoO₂, LiMnO₂, LiMn₂O₄, LiFePO₄, and LiFeVO₄, a portion of the atoms therein optionally being substituted; transition metal sulfides such as TiS₂, TiS₃, and amorphous MoS₃; and transition metal oxides such as Cu₂V₂O₃, amorphous V₂O.P₂O₅, MoO₃, V₂O₅, and V₆O₁₃. Among these, using a Li₂MnO₃—LiNiO₂ based solid solution as the positive electrode active material is preferable from the perspective of sufficiently increasing the capacity of an electrochemical element having a positive electrode formed using the composite particles for a positive electrode obtained with the slurry composition.

Note that when using a Ni containing positive electrode active material such as a Li₂MnO₃—LiNiO₂ based solid solution as the positive electrode active material, the positive electrode active material may be coated with a coating material that includes a conductive material and a coating resin that does not dissolve in an aqueous medium and that swells without dissolving upon contact with an electrolysis solution (organic electrolysis solution) normally used in an electrochemical element. A water soluble corrosive material (alkali content), such as lithium carbonate used during production of the active material, remains in the above Ni containing positive electrode active material. By coating the Ni containing positive electrode active material with the above coating material, however, the coating resin suppresses the elution of corrosive material, thereby suppressing corrosion of the collector upon formation of the positive electrode while guaranteeing conductivity due to the conductive material. As the coating resin with the to above properties, a resin having an SP value (solubility parameter) of preferably at least 9.5 (cal/cm³)^{1/2}, more preferably at least 10 (cal/cm³)^{1/2}, preferably at most 13 (cal/cm³)^{1/2}, and more preferably at most 12 (cal/cm³)^{1/2} may be used. The positive electrode active material can be coated with the coating material using fluidized granulation, spray granulation, coagulant precipitation, pH precipitation, or other such method.

The above SP value (solubility parameter) can be determined using the method described in “Polymer Handbook” VII Solubility Parameter Values, edited by E. H. Immergut, pp. 519-559 (John Wiley & Sons, 3^{rd} edition, 1989). For polymers not listed in this publication, the SP value can be determined with “the molecular attraction constant method” proposed by Small. This method determines the SP value (δ) with the following equation, based on characteristics of the functional group (atom group) forming a compound molecule, i.e. molecular attraction constant (G) statistics, the molecular weight (M), and the specific gravity (d).

δ=ΣG/V=dΣG/M(V: specific volume, M: molecular weight, d: specific gravity)

### <<Conductive Material>>

The conductive material is not particularly limited, and a known conductive material may be used. Examples of the conductive material include acetylene black, Ketjen black (registered trademark), carbon black, graphite, or other such conductive carbon material; and any of a variety of metallic fibers and foils. From the perspectives of improving the electrical contact between portions of the positive electrode active material so as to improve the electrical characteristics of an electrochemical element having a positive electrode formed using the composite particles for a positive electrode obtained with the slurry composition, acetylene black, Ketjen black (registered trademark), carbon black, and graphite are preferable among the above materials for the conductive material. Use of acetylene black is particularly preferable.

The content of the conductive material in the slurry composition is not particularly limited, yet per 100 parts by mass of the positive electrode active material, the content is preferably at least 1 part by mass, more preferably at least 2 parts by mass, and even more preferably at least 3 parts by mass, and the content is preferably at most 10 parts by mass and more preferably at most 8 parts by mass. By setting the content of the conductive material to be within the above ranges, a high capacity can be made compatible with high rate characteristics in the electrochemical element having a positive electrode formed using the composite particles for a positive electrode obtained with the slurry composition.

Note that when using the positive electrode active material coated with the coating material, normally only a portion of the conductive material included in the slurry composition is included in the coating material, yet the entire amount may be included in the coating material.

### <<Water Soluble Resin Including a Monomeric Unit Containing an Acidic Functional Group>>

The water soluble resin including a monomeric unit containing an acidic functional group (also referred to below as a “water soluble resin containing an acidic functional group”) is, for example, a resin that dissolves at a concentration of at least 10% by mass in an aqueous medium at pH 9 and preferably is a resin that dissolves at a concentration of at least 10% by mass in an aqueous medium at a pH in a range from 5 to 9.

Note that when a Ni containing positive electrode active material is used as the positive electrode active material, the water soluble resin containing an acidic functional group neutralizes the alkaline corrosive material that is eluted from the Ni containing positive electrode active material and also suppresses corrosion of the collector upon formation Of the positive electrode.

The content of the water soluble resin containing an acidic functional group in the slurry composition is preferably at least 1 part by mass, preferably at most 10 parts by mass, and more preferably at most 5 parts by mass per 100 parts by mass of the positive electrode active material. Setting the content of the water soluble resin containing an acidic functional group to be at least 1 part by mass per 100 parts by mass of the positive electrode active material can enhance the dispersiveness of the slurry composition. Furthermore, setting the content of the water soluble resin containing an acidic functional group to be at most 10 parts by mass per 100 parts by mass of the positive electrode active material sufficiently improves the electrical characteristics of an electrochemical element having a positive electrode formed using the composite particles for a positive electrode obtained with the slurry composition.

The water soluble resin containing an acidic functional group can be prepared by addition polymerization of a monomer containing an acidic functional group and, as necessary, a monomeric composition including any other monomer. Examples of a monomer containing an acidic functional group that can be used in production of the water soluble resin containing an acidic functional group include a monomer containing a phosphoric acid group, a monomer containing a sulfonic acid group, and a monomer containing a carboxyl group. By using a water soluble resin that includes a monomeric unit containing at least one selected from the group consisting of a monomeric unit containing a phosphoric acid group, a monomeric unit containing a sulfonic acid group, and a monomeric unit containing a carboxyl group, corrosion of the collector can be sufficiently suppressed.

Note that in the present disclosure, “includes a monomeric unit” means “a structural unit derived from a monomer is included in the polymer obtained using the monomer”.

The monomer containing a phosphoric acid group that can be used in production of the water soluble resin containing an acidic functional group is a monomer containing a phosphoric acid group and a polymerizable group that can copolymerize with another monomer. Examples of the monomer containing a phosphoric acid group include a monomer containing a —O—P(═O)(—OR¹)—OR² group (R¹ and R² independently represent a hydrogen atom or any organic group) or a salt thereof. Examples of an organic group as R¹ and R² include an aliphatic group such as an octyl group, an aromatic group such as a phenyl group, and the like.

Examples of the monomer containing a phosphoric acid group that can be used in production of the water soluble resin containing an acidic functional group include a compound containing a phosphoric acid group and an allyloxy group; and a phosphoric acid group-containing (meth)acrylic acid ester. An example of a compound containing a phosphoric acid group and an allyloxy group is 3-allyloxy-2-hydroxypropane phosphate. Examples of a phosphoric acid group-containing (meth)acrylic acid ester include dioctyl-2-methacryloyloxyethyl phosphate, diphenyl-2-methacryloyloxyethyl phosphate, monomethyl-2-methacryloyloxyethyl phosphate, dimethyl-2-methacryloyloxyethyl phosphate, monoethyl-2-methacryloyloxyethyl phosphate, diethyl-2-methacryloyloxyethyl phosphate, monoisopropyl-2-methacryloyloxyethyl phosphate, diisopropyl-2-methacryloyloxyethyl phosphate, mono-n-butyl-2-methacryloyloxyethyl phosphate, di-n-butyl-2-methacryloyloxyethyl phosphate, monobutoxyethyl-2-methacryloyloxyethyl phosphate, dibutoxyethyl-2-methacryloyloxyethyl phosphate, mono(2-ethylhexyl)-2-methacryloyloxyethyl phosphate, di(2-ethylhexyl)-2-methacryloyloxyethyl phosphate, and the like.

Note that in the present disclosure, (meth)acrylic acid refers to acrylic acid and/or methacrylic acid, and (meth)acrylic acid ester refers to acrylic acid ester and/or methacrylic acid ester.

The monomer containing a sulfonic acid group that can be used in production of the water soluble resin containing an acidic functional group is a monomer containing a sulfonic acid group and a polymerizable group that can copolymerize with another monomer. Examples of the monomer containing a sulfonic acid group include a monomer containing a sulfonic acid group with no functional group other than the sulfonic acid group and a polymerizable group, and salts thereof; a monomer containing an amide group in addition to a sulfonic acid group and a polymerizable group, and salts thereof; and a monomer containing a hydroxyl group in addition to a sulfonic acid group and a polymerizable group, and salts thereof.

Examples of a monomer containing a sulfonic acid group with no functional group other than the sulfonic acid group and a polymerizable group include vinyl sulfonic acid, styrene sulfonic acid, allyl sulfonic acid, sulfoethyl methacrylate, sulfopropyl methacrylate, sulfobutyl methacrylate, and the like. Examples of salts thereof include lithium salt, sodium salt, potassium salt, and the like. Examples of the monomer containing an amide group in addition to a sulfonic acid group and a polymerizable group include 2-acrylamide-2-methylpropane sulfonic acid (AMPS) and the like. Examples of salts thereof include lithium salt, sodium salt, potassium salt, and the like. Examples of the monomer containing a hydroxyl group in addition to a sulfonic acid group and a polymerizable group include 3-allyloxy-2-hydroxypropane sulfonic acid (HAPS) and the like. Examples of salts thereof include lithium salt, sodium salt, potassium salt, and the like. Among these, styrene sulfonic acid, 2-acrylamide-2-methylpropane sulfonic acid (AMPS), and salts thereof are preferable.

The monomer containing a carboxyl group that can be used in production of the water soluble resin containing an acidic functional group can be a monomer containing a carboxyl group and a polymerizable group. Examples of the monomer containing a carboxyl group include an ethylenically unsaturated carboxylic acid monomer.

Examples of the ethylenically unsaturated carboxylic acid monomer include an ethylenically unsaturated monocarboxylic acid and derivatives thereof, as well as an ethylenically unsaturated dicarboxylic acid, acid anhydrides thereof, and derivatives of the ethylenically unsaturated dicarboxylic acid and the acid anhydrides thereof. Examples of the ethylenically unsaturated monocarboxylic acid include acrylic acid, methacrylic acid, and crotonic acid. Examples of derivatives of the ethylenically unsaturated monocarboxylic acid include 2-ethylacrylic acid, isocrotonic acid, α-acetoxyacrylic acid, β-trans-aryloxyacrylic acid, α-chloro-β-E-methoxyacrylic acid, and β-diaminoacrylic acid. Examples of the ethylenically unsaturated dicarboxylic acid include maleic acid, fumaric acid, and itaconic acid. Examples of acid anhydrides of the ethylenically unsaturated dicarboxylic acid include maleic anhydride, acrylic anhydride, methylmaleic anhydride, and dimethylmaleic anhydride. Examples of derivatives of the ethylenically unsaturated dicarboxylic acid include methylmaleic acid, dimethylmaleic acid, phenylmaleic acid, chloromaleic acid, dichloromaleic acid, fluoromaleic acid, or other maleic acid methylallyl; and diphenyl maleate, nonyl maleate, decyl maleate, dodecyl maleate, octadecyl maleate, fluoroalkyl maleate, or other maleic acid ester. Among these, an ethylenically unsaturated monocarboxylic acid such as acrylic acid, methacrylic acid, and the like is preferable. The reason is that the dispersiveness in an aqueous solvent of the resulting water soluble resin containing an acidic functional group is further increased.

It is possible to use only one of the above monomers containing an acidic functional group alone, or to use two or more types in combination. Accordingly, the water soluble resin containing an acidic functional group used in the present invention may include only one type of monomeric unit containing an acidic functional group or may include two or more types in combination.

The content by percentage of the monomeric unit containing an acidic functional group in the water soluble resin containing an acidic functional group used in the present invention is preferably at least 5% by mass, more preferably at least 10% by mass, and even more preferably at least 20% by mass. Furthermore, the content is preferably at most 60% by mass, more preferably at most 50% by mass, and even more preferably at most 40% by mass. Setting the content by percentage of the monomeric unit containing an acidic functional group to be at least 5% by mass facilitates electrostatic repulsion from the positive electrode active material in the slurry composition, thus achieving good dispersiveness. On the other hand, setting the content by percentage of the monomeric unit containing an acidic functional group to be at most 60% by mass avoids excessive contact between the functional group and the electrolysis solution when a positive electrode is formed using the composite particles, thereby enhancing durability.

The water soluble resin containing an acidic functional group used in the present invention may include another monomeric unit in addition to the monomeric unit containing an acidic functional group. Examples of another monomeric unit include a fluorine-containing (meth)acrylic acid ester monomeric unit, a crosslinkable monomeric unit, a reactive surfactant monomeric unit, and a monomeric unit of (meth)acrylic acid ester not containing fluorine. Note that in the present disclosure, the term “monomeric unit of (meth)acrylic acid ester” is taken to refer to a “monomeric unit of (meth)acrylic acid ester not containing fluorine”.

Examples of the fluorine-containing (meth)acrylic acid ester monomer that can be used in production of the water soluble resin containing an acidic functional group include monomers represented by Formula (I) below.

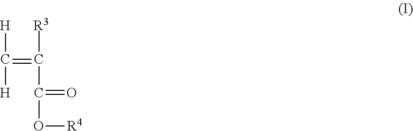

In Formula (I), R³ represents a hydrogen atom or a methyl group. Furthermore, in Formula (I), R⁴ represents a hydrocarbon group containing a fluorine atom. The carbon number of the hydrocarbon group is normally at least 1 and at most 18. The number of fluorine atoms contained in R⁴ may be 1, or the number may be 2 or more.

Examples of the fluorine-containing (meth)acrylic acid ester monomer represented by Formula (I) include (meth)acrylic acid alkyl fluoride ester, (meth)acrylic acid aryl fluoride ester, and (meth)acrylic acid aralkyl fluoride ester. Among these, (meth)acrylic acid alkyl fluoride ester is preferable. Examples of such monomers include (meth)acrylic acid perfluoroalkyl esters such as (meth)acrylic acid 2,2,2-trifluoroethyl ester, (meth)acrylic acid β-(perfluorooctyl)ethyl ester, (meth)acrylic acid 2,2,3,3-tetrafluoropropyl ester, (meth)acrylic acid 2,2,3,4,4,4-hexafluorobutyl ester, (meth)acrylic acid 1H,1H,9H-perfluoro-1-nonyl ester, (meth)acrylic acid 1H,1H,11H-perfluoroundecyl ester, (meth)acrylic acid perfluorooctyl ester, (meth)acrylic acid trifluoromethyl ester, and (meth)acrylic acid 3(4{1-trifluoromethyl-2,2-bis[bis(trifluoromethyl)fluoromethyl]ethynyloxy}benzooxy)-2-hydroxypropyl ester, and the like. It is possible to use only one of the above alone, or to use two or more types in combination.

The content by percentage of the fluorine-containing (meth)acrylic acid ester monomeric unit in the water soluble resin containing an acidic functional group used in the present invention is preferably at least 1% by mass, more preferably at least 2% by mass, and even more preferably at least 5% by mass. Furthermore, the content is preferably at most 20% by mass, to more preferably at most 15% by mass, and even more preferably at most 10% by mass. Setting the content by percentage of the fluorine-containing (meth)acrylic acid ester monomeric unit to be at least 1% by mass provides the water soluble resin containing an acidic functional group with repulsion with respect to the electrolysis solution, thereby keeping the swellability with respect to the electrolysis solution in an appropriate range. On the other hand, setting the ratio of the fluorine-containing (meth)acrylic acid ester monomeric unit to be at most 20% by mass provides the water soluble resin containing an acidic functional group with wettability with respect to the electrolysis solution, thereby improving the low temperature output characteristics. Furthermore, appropriately adjusting the ratio of the fluorine-containing (meth)acrylic acid ester monomeric unit to be within the above ranges yields a water soluble resin containing an acidic, functional group that has the desired glass transition temperature and molecular weight distribution.

As the crosslinkable monomer that can be used in production of the water soluble resin containing an acidic functional group, a monomer that can form a crosslinked structure when polymerized can be used. Examples of the crosslinkable monomer include a monomer having two or more reactive groups per molecule. In greater detail, examples include a monofunctional monomer having a thermal crosslinking group and one olefinic double bond per molecule, and a multifunctional monomer having two or more olefinic double bonds per molecule.

Examples of the thermal crosslinking group included in the monofunctional monomer include an epoxy group, N-methylol amide group, oxetanyl group, oxazoline group, and combinations thereof. Among these, an epoxy group is preferable for the ease with which its crosslink and crosslink density can be adjusted.

Examples of the crosslinkable monomer having an epoxy group as the thermal crosslinking group and having an olefinic double bond include vinyl glycidyl ether, allyl glycidyl ether, butenyl glycidyl ether, o-allyl phenyl glycidyl ether, or other unsaturated glycidyl ether; butadiene monoepoxide, chloroprene monoepoxide, 4,5-epoxy-2-pentene, 3,4-epoxy-1-vinyl cyclohexene, 1,2-epoxy-5,9-cyclododecadiene, or other monoepoxide of diene or polyene; 3,4-epoxy-1-butene, 1,2-epoxy-5-hexene, 1,2-epoxy-9-decene, or other alkenyl epoxide; as well as glycidyl acrylate, glycidyl methacrylate, glycidyl crotonate, glycidyl-4-heptenoate, glycidyl sorbate, glycidyl linoleate, glycidyl-4-methyl-3-pentenoate, glycidyl ester of 3-cyclohexenecarboxylic acid, glycidyl ester of 4-methyl-3-cyclohexenecarboxylic acid, or other glycidyl ester of unsaturated monocarboxylic acid.

Examples of the crosslinkable monomer having an N-methylol amide group as the thermal crosslinking group and having an olefinic double bond include (meth)acrylamides having a methylol group such as N-methylol(meth)acrylamide.

Examples of the crosslinkable monomer having an oxetanyl group as the thermal crosslinking group and having an olefinic double bond include 3-[(meth)acryloyloxymethyl]oxetane, 3-[(meth)acryloyloxymethyl]-2-trifluoromethyloxetane, 3-[(meth)acryloyloxymethyl]-2-phenyloxetane, 2-[(meth)acryloyloxymethyl]oxetane, and 2-[(meth)acryloyloxymethyl]-4-trifluoromethyloxetane.

Examples of the crosslinkable monomer having an oxazoline group as the thermal crosslinking group and having an olefinic double bond include 2-vinyl-2-oxazoline, 2-vinyl-4-methyl-2-oxazoline, 2-vinyl-5-methyl-2-oxazoline, 2-isopropenyl-2-oxazoline, 2-isopropenyl-4-methyl-2-oxazoline, 2-isopropenyl-5-methyl-2-oxazoline, and 2-isopropenyl-5-ethyl-2-oxazoline.

Examples of the multifunctional monomer having two or more olefinic double bonds include allyl(meth)acrylate, ethylene di(meth)acrylate, diethylene glycol di(meth)acrylate, triethylene glycol di(meth)acrylate, tetraethylene glycol di(meth)acrylate, trimethylolpropane-tri(meth)acrylate, dipropylene glycol diallyl ether, polyglycol diallyl ether, triethylene glycol divinylether, hydroquinone diallyl ether, tetraallyloxyethane, trimethylolpropane-diallyl ether, an allyl or vinyl ether of a multifunctional alcohol other than those listed above, triallylamine, methylene bisacrylamide, and divinyl benzene.

Among these, from the perspectives of suppressing an increase in viscosity of the slurry composition due to cross-linking at the time of drying, and of increasing strength of the positive electrode produced using the composite particles, ethylene dimethacrylate, allyl glycidyl ether, and glycidyl methacrylate are particularly preferable for use as the crosslinkable monomer.

The content by percentage of the crosslinkable monomeric unit in the water soluble resin containing an acidic functional group used in the present invention is preferably at least 0.1% by mass, more preferably at least 0.2% by mass, and even more preferably at least 0.5% by mass. Furthermore, the content is preferably at most 2% by mass, more preferably at most 1.5% by mass, and even more preferably at most 1% by mass. Setting the content by percentage of the crosslinkable monomeric unit to be within the above ranges suppresses the degree of swelling of the water soluble resin containing an acidic functional group and increases the durability of the positive electrode. Furthermore, appropriately adjusting the content by percentage of the crosslinkable monomeric unit to be within the above ranges yields a water soluble resin containing an acidic functional group that has the desired glass transition temperature and molecular weight distribution.

A reactive surfactant monomer that can be used in production of the water soluble resin containing an acidic functional group is a monomer containing a polymerizable group that can copolymerize with another monomer and containing a surfactant group (hydrophilic group and hydrophobic group). The reactive surfactant monomeric unit obtained by polymerization of a reactive surfactant monomer constitutes a portion of a water soluble polymer molecule and can achieve a surface activating effect. Therefore, stability at the time of production of the water soluble resin containing an acidic functional group improves.

Suitable examples of the reactive surfactant monomer include the compounds represented by Formula (II) below.

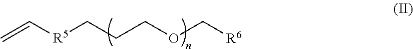

In Formula (II), R⁵ represents a divalent linking group. Examples of R⁵ include a —Si—O-group, methylene group, and phenylene group. Furthermore, in Formula (II), R⁶ represents a hydrophilic group. Examples of R⁶ include —SO₃NH₄. In Formula (II), n represents an integer from 1 to 100. It is possible to use only one type of reactive surfactant monomer or to use two or more types in combination at any ratio.

Other suitable examples of the reactive surfactant monomer include compounds containing a polymeric unit based on ethyleneoxide and a polymeric unit based on butyleneoxide and containing, at a terminal, an alkenyl group having a terminal double bond and —SO₃NH₄ (for example, products by the names of “LATEMUL PD-104” and “LATEMUL PD-105” manufactured by Kao Corporation).

The content by percentage of the reactive surfactant monomeric unit in the water soluble resin containing an acidic functional group used in the present invention is preferably at least 0.1% by mass, more preferably at least 0.2% by mass, and even more preferably at least 0.5% by mass. Furthermore, the content is preferably at most 5% by mass, more preferably at most 4% by mass, and even more preferably at most 2% by mass. Setting the ratio of the reactive surfactant monomeric unit to be at least 0.1% by mass allows for an increase in the dispersiveness of the water soluble resin containing an acidic functional group in the slurry composition upon production of the composite particles. On the other hand, setting the ratio of the reactive surfactant monomeric unit to be at most 5% by mass enhances the durability of the positive electrode.

Examples of the monomer of (meth)acrylic acid ester not containing fluorine that can be used in production of the water soluble resin containing an acidic functional group include methyl acrylate, ethyl acrylate, n-propyl acrylate, isopropyl acrylate, n-butyl acrylate, t-butyl acrylate, pentyl acrylate, hexyl acrylate, heptyl acrylate, octyl acrylate, 2-ethylhexyl acrylate, nonyl acrylate, decyl acrylate, lauryl acrylate, n-tetradecyl acrylate, stearyl acrylate, or other acrylic acid alkyl ester; and methyl methacrylate, ethyl methacrylate, n-propyl methacrylate, isopropyl methacrylate, n-butyl methacrylate, t-butyl methacrylate, pentyl methacrylate, hexyl methacrylate, heptyl methacrylate, octyl methacrylate, 2-ethylhexyl methacrylate, nonyl methacrylate, decyl methacrylate, lauryl methacrylate, n-tetradecyl methacrylate, stearyl methacrylate, or other methacrylic acid alkyl esters. Among these monomers of (meth)acrylic acid ester not containing fluorine, butyl acrylate and ethyl acrylate are preferable. It is possible to use only one of the above alone, or to use two or more types in combination.

The content by percentage of the monomeric unit of (meth)acrylic acid ester in the water soluble resin containing an acidic functional group used in the present invention is preferably at least 30% by mass, more preferably at least 35% by mass, and even more preferably at least 40% by mass. Furthermore, the content is preferably at most 90% by mass, more preferably at most 80% by mass, and even more preferably at most 70% by mass. Setting the content by percentage of the monomeric unit of (meth)acrylic acid ester to be at least 30% by mass increases adhesiveness of the composite particles to the collector, whereas setting the content by percentage to be at most 90% by mass suppresses a decrease in the water solubility of the water soluble resin containing an acidic functional group while maintaining a balance with the content by percentage of the other monomers.

Examples of monomeric units that can be included in the water soluble resin containing an acidic functional group used in the present invention other than those listed above include monomeric units derived from the following monomers. Specifically, the monomeric unit obtained by polymerizing one or more of the following may be used: styrene, chlorostyrene, vinyl toluene, t-butylstyrene, vinylbenzoic acid methyl ester, vinyl naphthalene, chloromethylstyrene, hydroxymethylstyrene, α-methylstyrene, divinyl benzene, or other styrene-based monomer; acrylamide or other amide-based monomer; acrylonitrile, methacrylonitrile, or other α,β-unsaturated nitrile compound monomer; ethylene, propylene, or other olefin-type monomer; vinyl chloride, vinylidene chloride, or other halogen atom-containing monomer; vinyl acetate, vinyl propionate, vinyl butyrate, vinyl benzoate, or other vinylester-type monomer; methylvinylether, ethylvinylether, butylvinylether, or other vinylether-type monomer; methylvinylketone, ethylvinylketone, butylvinylketone, hexylvinylketone, isopropenylvinylketone, or other vinylketone-type monomer; and N-vinylpyrrolidone, vinylpyridine, vinylimidazole, or other heterocyclic group-containing vinyl compound monomer. The content by percentage of these units in the water soluble resin containing an acidic functional group is preferably from 0% by mass to 10% by mass, and more preferably from 0% by mass to 5% by mass.

The water soluble resin containing an acidic functional group used in the present invention can be produced with any method for production. For example, the water soluble resin containing an acidic functional group can be produced by addition polymerization, in an aqueous solvent, of a monomeric composition including a monomer containing an acidic functional group and, as necessary, a monomer providing any other unit. As the aqueous solvent used in the polymerization reaction, a known aqueous solvent may be used, for example as disclosed in JP2011204573A, the entire contents of which are incorporated herein by reference. Among these, water is preferable.

An addition polymerization reaction in such an aqueous solvent yields an aqueous solution in which water soluble resin containing an acidic functional group is dissolved in the aqueous solvent. The water soluble resin containing an acidic functional group may be extracted from the resulting aqueous solution, yet the slurry composition may be produced using the water soluble resin containing an acidic functional group in a dissolved state in the aqueous solvent.

The glass transition temperature of the water soluble resin containing an acidic functional group used in the present invention is preferably at least 30° C., more preferably at least 35° C., and even more preferably at least 40° C. Furthermore, the glass transition temperature is preferably at most 80° C., more preferably at most 75° C., and even more preferably at most 70° C. Setting the glass transition temperature to be at least 30° C. enhances the durability of the positive electrode obtained by using the composite particles. Setting the glass transition temperature to be at most 80° C. enhances the adhesiveness of the composite particles to the collector.

The number average molecular weight of the water soluble resin containing an acidic functional group used in the present invention is preferably at least 1000, more preferably at least 1500, and even more preferably at least 2000. Furthermore, the number average molecular weight is preferably at most 100000, more preferably at most 80000, and even more preferably at most 60000. Setting the number average molecular weight to be within the above ranges heightens the water solubility of the water soluble resin containing an acidic functional group while also enhancing the durability of the positive electrode produced by using the composite particles.

Using GPC (Gel Permeation Chromatography), the number average molecular weight of the water soluble resin containing an acidic functional group can be calculated as the value in terms of polystyrene, using as the developing solvent a solution in which 0.85 g/ml of sodium nitrate are dissolved in a 10% by volume aqueous solution of dimethylformamide.

Note that the glass transition temperature and number average molecular weight of the water soluble resin containing an acidic functional group can be adjusted by combining a variety of monomers or by using a known molecular weight modifier.

### <<Granular Binder Resin>>

The granular binder resin is a component that, in the positive electrode active material layer formed on the collector using the composite particles obtained from the slurry composition according to the present invention, can keep the components included in the positive electrode active material layer from separating from the positive electrode active material layer. In general, the granular binder resin in the positive electrode active material layer absorbs the electrolysis solution upon immersion in the electrolysis solution and swells while maintaining a granular shape, thereby promoting binding between portions of the positive electrode active material and preventing the positive electrode active material from falling off the collector. By including the granular binder resin in the composite particles, the positive electrode formed by using the composite particles can achieve a structure such that, in the electrolysis solution, the positive electrode has holes, yet the positive electrode active material is bound evenly by the granular binder resin. Accordingly, the electrochemical element using the positive electrode can maintain good capabilities.

In the present invention, a granular binder resin that can be dispersed in an aqueous medium is preferably used as the granular binder resin. It is possible to use only one type of granular binder resin, or to use two or more types in combination.

Preferable examples of the granular binder resin include a diene polymer, acrylic polymer, fluoropolymer, silicon polymer, and the like. Among these, an acrylic polymer is preferable for its excellent oxidation resistance.

The acrylic polymer used as the granular binder resin is a polymer that includes a monomeric unit of (meth)acrylic acid ester. Among such polymers, a polymer that includes a monomeric unit of (meth)acrylic acid ester and includes at least one of a monomeric unit containing an acidic functional group and an α,β-unsaturated nitrile monomeric unit is preferable. A polymer that includes a monomeric unit of (meth)acrylic acid ester with a carbon number of 6 to 15, an α,β-unsaturated nitrile monomeric unit, and a monomeric unit containing a carboxylic acid group is more preferable.

Examples of the monomer of (meth)acrylic acid ester that can be used in production of the acrylic polymer include monomers similar to those listed in the section on the water soluble resin containing an acidic functional group. Among these, monomers having a carbon number of at least 6, more preferably at least 7, and a carbon number of at most 15, more preferably at most 13, are preferable since such monomers can extend battery life and exhibit good ion conductivity due to appropriate swelling with respect to the electrolysis solution without being eluted in the electrolysis solution upon formation of a positive electrode using the composite particles. Among these, 2-ethylhexyl acrylate is particularly preferable. It is possible to use only one of the above alone, or to use two or more types in combination.

The content by percentage of the monomeric unit of (meth)acrylic acid ester in the acrylic polymer used as the granular binder resin is preferably at least 50% by mass and more preferably at least 60% by mass. Furthermore, the content is preferably at most 95% by mass and more preferably at most 90% by mass. Setting the content by percentage of the monomeric unit derived from a monomer of (meth)acrylic acid ester to be at least 50% by mass increases the flexibility of the granular binder resin and makes it difficult for the positive electrode obtained by using the composite particles to crack. Furthermore, setting the content by percentage to be at most 95% by mass enhances the mechanical strength and binding properties of the granular binder resin.

Examples of the monomer containing an acidic functional group that can be used in production of the acrylic polymer include the monomers containing a carboxylic acid group, monomers containing a sulfonic acid group, and monomers containing a phosphoric acid group listed in the section on the water soluble resin containing an acidic functional group. Among these, acrylic acid, methacrylic, acid, methyl methacrylic acid ester, itaconic acid, 2-acrylamide-2-methylpropane sulfonic acid (AMPS), and phosphoric acid ethylene methacrylate are preferable. Furthermore, from the perspective of being able to increase preservation stability of the acrylic polymer, acrylic acid, methacrylic acid, and itaconic acid are preferable, with itaconic acid being particularly preferable.

As the monomer containing an acidic functional group used in production of the acrylic polymer, use of a dibasic acid monomer is preferable. In other words, the acrylic polymer preferably includes a monomeric unit of dibasic acid. Including a monomeric unit of dibasic acid provides the acrylic polymer with increased preservation stability. Furthermore, ion conductivity improves, and battery life is extended. Examples of the dibasic acid monomer include itaconic acid, mesaconic acid, citraconic acid, maleic acid, and fumaric acid. Among these, itaconic acid is preferable.

A monomeric unit of dibasic acid also provides a granular binder resin composed of a polymer other than an acrylic polymer with the above-described good ion conductivity and can increase battery life. Additionally, such a granular binder resin achieves the effects of excellent preservation stability, mechanical strength, and binding properties. In other words, the granular binder resin preferably includes a monomeric unit of dibasic acid.

It is possible to use only one type of the above monomers containing an acidic functional group alone, or to use two or more types in combination.

The content by percentage of the monomeric unit containing an acidic functional group in the acrylic polymer used as the granular binder resin is preferably at least 1% by mass and more preferably at least 1.5% by mass. Furthermore, the content is preferably at most 5% by mass and more preferably at most 4% by mass. Setting the content by percentage of the monomeric unit containing an acidic functional group to be at least 1% by mass allows for an increase in the binding properties of the granular binder resin and improves the rate characteristics of the electrochemical element. Furthermore, setting the content by percentage to be at most 5% by mass allows for good production stability and preservation stability of the acrylic polymer.

As an α,β-unsaturated nitrile monomer, acrylonitrile or methacrylonitrile, for example, are preferable from the viewpoint of improving the mechanical strength and binding properties, with acrylonitrile being particularly preferable. It is possible to use only one type of the above alone, or to use two or more types in combination.

The content by percentage of the α,β-unsaturated nitrile monomeric unit in the acrylic polymer used as the granular binder resin is preferably at least 3% by mass and more preferably at least 5% by mass. Furthermore, the content is preferably at most 40% by mass and more preferably at most 30% by mass. Setting the content by percentage of the α,β-unsaturated nitrile monomeric unit to be at least 3% by mass enhances the mechanical strength of the granular binder resin and improves adhesiveness between the positive electrode active material and the collector, as well as between portions of the positive electrode active material. Setting the content to be at most 40% by mass increases the flexibility of the granular binder resin and makes it difficult for the positive electrode obtained by using the composite particles to crack.

The acrylic polymer used as the granular binder resin may include a crosslinkable monomeric unit. Examples of the crosslinkable monomer include monomers similar to those listed in the section on the water soluble resin containing an acidic functional group. It is possible to use only one type of the above alone, or to use two or more types in combination.

The content by percentage of the crosslinkable monomeric unit in the acrylic polymer used as the granular binder resin is preferably at least 0.01% by mass and more preferably at least 0.05% by mass. Furthermore, the content is preferably at most 0.5% by mass and more preferably at most 0.3% by mass. Setting the content by percentage of the crosslinkable monomeric unit to be within the above ranges allows the acrylic polymer to exhibit appropriate swellability with respect to the electrolysis solution and further improves the rate characteristics and cycle characteristics of an electrochemical element using the positive electrode obtained by using the composite particles.

Furthermore, the acrylic polymer may include a monomeric unit derived from a monomer, other than those described above. Examples of such a monomer include monomers similar to those listed in the section on the water soluble resin containing an acidic functional group. It is possible to use only one type of the above alone, or to use two or more types in combination.

The method for producing the granular binder resin is not particularly limited. Any of the following methods, for example, may be used: a solution polymerization method, suspension polymerization method, bulk polymerization method, emulsion polymerization method, or the like. As a polymerization method, an addition polymerization such as an ionic polymerization, radical polymerization, living radical polymerization, or the like may be used. As a polymerization initiator, any known polymerization initiator may be used, such as those disclosed in JP2012184201A, the entire contents of which are incorporated herein by reference.

The granular binder resin is normally produced in a dispersion liquid state, in which the granular binder resin is dispersed as particles within an aqueous medium. The granular binder resin is similarly included in a dispersed particle state in an aqueous medium in the slurry composition for producing the composite particles for a positive electrode of an electrochemical element. In the case of dispersion as particles within an aqueous medium, the 50% volume average particle size of the particles of the granular binder resin is preferably at least 50 nm, more preferably at least 60 nm, and even more preferably at least 70 nm. Furthermore, the 50% volume average particle size is preferably at most 200 nm, more preferably at most 185 nm, and even more preferably at most 160 nm. Setting the volume average particle size of the particles of the granular binder resin to be at least 50 nm improves the stability of the slurry composition. On the other hand, setting the volume average particle size to be at most 200 nm improves the binding properties of the granular binder resin.

The granular binder resin is normally stored and transported in the form of the above dispersion liquid. The solid content concentration of such a dispersion liquid is normally at least 15% by mass, preferably at least 20% by mass, and more preferably at least 30% by mass. Furthermore, the solid content concentration is normally at most 70% by mass, preferably at most 65% by mass, and more preferably at most 60% by mass. A solid content concentration of the dispersion liquid within the above ranges offers good workability when producing the slurry composition.

The pH of the dispersion liquid that includes the granular binder resin is preferably at least 5 and more preferably at least 7. Furthermore, the pH is preferably at most 13 and more preferably at most 11. Setting the pH of the dispersion liquid to be within the above ranges enhances stability of the granular binder resin.

The glass transition temperature of the granular binder resin is preferably at least −50° C., more preferably at least −45° C., and even more preferably at least −40° C. Furthermore, the glass transition temperature is preferably at most 25° C., more preferably at most 15° C., and even more preferably at most 5° C. Setting the glass transition temperature of the granular binder resin to be within the above ranges enhances strength and flexibility of the positive electrode produced using the composite particles and achieves superior low temperature output characteristics. Note that the glass transition temperature of the granular binder resin can be modified by, for example, changing the combination of monomers forming the monomeric units.

Per 100 parts by mass of the positive electrode active material, the content of the granular binder resin in the slurry composition according to the present invention is preferably at least 0.1 parts by mass and more preferably at least 0.5 parts by mass, and the content is preferably at most 5 parts by mass and more preferably at most 3 parts by mass. Setting the content of the granular binder resin to be at least 0.1 parts by mass per 100 parts by mass of the positive electrode active material increases the binding properties between portions of the positive electrode active material, as well as between the composite particles and the collector, and also increases the rate characteristics. On the other hand, setting the content to be at most 5 parts by mass prevents the obstruction of ion transfer due to the granular binder resin when applying the positive electrode obtained by using the composite particles in an electrochemical element and reduces the internal resistance of to the battery.

### <<Other Components>>

In addition to the above components, the slurry composition according to the present invention may, for example, include components such as a reinforcing material, dispersant, antioxidant, thickener, electrolysis solution additive having the function of suppressing electrolysis solution decomposition, and the like. Known components may be used for these other components, such as the components disclosed in JP2012204303A, the entire contents of which are incorporated herein by reference.

Among these other components, carboxymethyl cellulose is preferably used as a thickener to adjust the viscosity of the slurry composition. Per 100 parts by mass of the positive electrode active material, the content of the carboxymethyl cellulose in the slurry composition according to the present invention is preferably at least 1 part by mass, preferably at most 10 parts by mass, and more preferably at most 5 parts by mass. Setting the content of the carboxymethyl cellulose to be within the above ranges allows for sufficient stabilization of the viscosity of the slurry composition.

Note that while the carboxymethyl cellulose is a water soluble resin, it is a cellulose derivative formed by condensation polymerization of β-glucose, and therefore does not qualify as a water soluble resin including a monomeric unit containing an acidic functional group.

### <<Moisture Content>>

The moisture content of the slurry composition according to the present invention needs to be at most 25% by mass. The moisture content of the slurry composition according to the present invention is preferably at least 20% by mass and more preferably at least 23% by mass. By setting the moisture content to be at most 25% by mass, the amount of time required to produce the composite particles by spray drying the slurry composition can be shortened, thus improving the productivity of the composite particles. Furthermore, by setting the moisture content to be at least 20% by mass, the viscosity of the slurry composition can be prevented from increasing excessively, which would make it difficult to perform dry granulation using spray drying at the time of producing composite particles.

<<Viscosity at a Shear Velocity of 10 s⁻¹>>

The viscosity of the slurry composition according to the present invention needs to be at most 2000 mPa·s at a shear velocity of 10 s⁻¹. The viscosity of the slurry composition according to the present invention is preferably at most 1500 mPa·s and more preferably at most 1000 mPa·s at a shear velocity of 10 s⁻¹. Setting the viscosity at a shear velocity of 10 s⁻¹ to be at most 2000 mPa·s allows for the efficient production of composite particles with good electrical characteristics by dry granulation using spray drying.

The reason for focusing on the “viscosity at a shear velocity of 10 s⁻¹” in the slurry composition according to the present invention is that when considering the magnitude of the shear force normally applied to the slurry composition upon production of composite particles by spray drying the slurry composition, composite particles with good electrical characteristics can be obtained efficiently by spray drying if the viscosity at a shear velocity of 10 s⁻¹ is sufficiently small.

The viscosity of the slurry composition at a shear velocity of 10 s⁻¹ can be lowered by, for example, increasing the moisture content of the slurry composition and by enhancing the dispersiveness of the components in the slurry composition (for example, by increasing the content of the water soluble resin including a monomeric unit containing an acidic functional group). Furthermore, the viscosity of the slurry composition at a shear velocity of 10 s⁻¹ can be controlled by adjusting factors such as the order in which the components of the slurry composition are mixed.

### <Method for Producing Composite Particles for Positive Electrode>

In the method for producing composite particles for a positive electrode according to the present invention, the above-described slurry composition for composite particles for a positive electrode according to the present invention is prepared as below, and the resulting slurry composition is spray dried to produce composite particles for a positive electrode.

### <<Preparation of Slurry Composition>>

In the method for producing the composite particles for a positive electrode according to the present invention, a mixture including a positive electrode active material, a conductive material, and a water soluble resin including a monomeric unit containing an acidic functional group is kneaded to obtain a kneaded mixture (kneading step), after which the above-described slurry composition is prepared by adding a granular binder resin and water to the kneaded mixture (slurry preparation step).

### —Kneading Step—

During the kneading step, the mixture including the positive electrode active material, the conductive material, and the water soluble resin including a monomeric unit containing an acidic functional group is kneaded using a kneading device to obtain a kneaded mixture. Examples of the kneading device used for kneading include a homogenizer, ball mill, bead mill, planetary mixer, sand mill, roll mill, double shaft roll, Banbury mixer, and a dispersion kneader such as an anisotropic double shaft kneader and a planetary kneader. Among these, a planetary mixer allows for efficient shearing and kneading, causes little loss of processed material, and makes post-production cleansing easy. Use of a planetary mixer is thus preferable. When the above-described “other components” are included in the slurry composition, the other components are also kneaded during the kneading step along with the positive electrode active material, the conductive material, and the water soluble resin including a monomeric unit containing an acidic functional group.

Kneading is normally performed at a temperature ranging from room temperature to 80° C. for 20 to 120 minutes, preferably from 30 to 60 minutes.

The water soluble resin that includes a monomeric unit containing an acidic functional group and is blended into the mixture is preferably formed as an ammonium salt by at least one selected from the group consisting of ammonia and an amine compound with a molecular weight of at most 1000 (referred to below as “low molecular weight compound X”). By thus forming a portion or the entirety of the acidic group in the water soluble resin including a monomeric unit containing an acidic functional group as an ammonium salt, the solubility of the water soluble resin with respect to water increases even if the slurry composition is prepared under alkaline conditions during the slurry preparation step described below, thus allowing for even dispersion of the water soluble resin within the slurry composition.

Note that since these low molecular weight compounds X that bond with the acidic functional group desorb at the time of forming the composite particles by spray drying the slurry composition, the acidic functional group in the resulting composite particles returns to the conditions before formation of an ammonium salt.

The molecular weight of the amine compound is at most 1000, yet to facilitate vaporization at the time of drying and granulating, the molecular weight is preferably at most 200 and more preferably at most 150. The amine compound with a molecular weight of at most 1000 is not particularly limited. Examples include secondary amines such as dimethylamine, diethylamine, and dibutylamine; tertiary amines such as trimethylamine, triethylamine, tributylamine, and diazabicyclononene; and the like.

Among ammonia and the above amine compounds with a molecular weight of at most 1000, ammonia is particularly preferable as the low molecular weight compound X. The reason is that ammonia volatilizes easily at the time of drying and granulating, and unlike when using an amine salt or the like, no impurity such as a metal element remains in the composite particles at the time of volatilization.

Per 100 parts by mass of the water soluble resin including a monomeric unit containing an acidic functional group, the content of the low molecular weight compound X is preferably at least 0.01 parts by mass, more preferably at least 0.05 parts by mass, and even more preferably at least 0.1 parts by mass, and the content is preferably at most 50 parts by mass, more preferably at most 40 parts by mass, and even more preferably at most 30 parts by mass. Setting the content of the low molecular weight compound X to be at least 0.01 parts by mass per 100 parts by mass of the water soluble resin including a monomeric unit containing an acidic functional group achieves sufficient solubility in water of the water soluble resin including a monomeric unit containing an acidic functional group, and setting the content to be at most 50 parts by mass allows for stable vaporization of the low molecular weight compound X at the time of dry granulation.

When the water soluble resin including a monomeric unit containing an acidic functional group is blended into the above mixture in the state of an aqueous solution, moisture derived from the aqueous solution is included in the mixture. Furthermore, an aqueous medium such as water is freely added to the mixture from the perspective of facilitating kneading. From the perspective of sufficiently kneading the mixture, the moisture content of the mixture is preferably at least 10% by mass and more preferably at least 13% by mass. Furthermore, the moisture content is preferably at most 20% by mass and more preferably at most 17% by mass. When the moisture content of the mixture is less than the above range, the shear force at the time of kneading might not be sufficient. Conversely, when the moisture content exceeds the above range, particles of the solid content may reaggregate.

So that sufficient kneading of the mixture in order to disperse the conductive material well allows for a sufficient increase in the electrical characteristics of a positive electrode formed using the composite particles produced in accordance with the method for production of composite particles for a positive electrode according to the present invention, the mixture is preferably kneaded by applying an energy of 50 MJ/m³ to 200 MJ/m³. The energy applied to the mixture is more preferably at least 70 MJ/m³, even more preferably at least 100 MJ/m³, and more preferably at most 180 MJ/m³. Kneading the mixture by applying an energy in the above ranges yields good dispersiveness for the positive electrode active material and the conductive material during the slurry preparation step described below and also lowers the viscosity of the slurry.

The energy applied to the mixture can be controlled by the moisture content of the mixture and by the circumferential speed of the mixing blade in the kneading device. Since the circumferential speed of the mixing blade in the kneading device varies according to the shape, size, etc. of the mixing blade, it is difficult to generalize. However, when using a planetary mixer, for example, the circumferential speed of the mixing blade is preferably 0.1 m/s to 2 m/s and more preferably 0.7 m/s to 1 m/s.

### —Slurry Preparation Step—

Next, during the slurry preparation step, a granular binder resin and to water are added to and mixed in with the kneaded mixture obtained in the kneading step so as to obtain a slurry composition in which the moisture content is at most 25% by mass, and the viscosity at a shear velocity of 10 s⁻¹ is at most 2000 mPa·s. When the granular binder resin is added in the state of a dispersion liquid, the water in the dispersion liquid is included in the water added during the slurry preparation step.

Mixing of the kneaded mixture, the granular binder resin, and the water may be performed using a mixer such as a ball mill, sand mill, bead mill, pigment disperser, grinder, ultrasonic disperser, homogenizer, planetary mixer, or the like. Among these, a planetary mixer allows for efficient slurry preparation and kneading with one mixer, causes little loss of processed material, and makes post-production cleansing easy. Use of a planetary mixer is thus preferable. Mixing is normally performed at a temperature ranging from room temperature to 50° C. for 10 minutes to several hours.

During the slurry preparation step, the granular binder resin and the water are added to the kneaded mixture obtained in the kneading step, and therefore the viscosity of the slurry composition is lower than when preparing a slurry composition by simultaneously mixing all of the components that are blended into the slurry composition. Furthermore, the conductive material becomes well dispersed. Note that during the slurry preparation step, the viscosity of the slurry composition can also be lowered by increasing the amount of water added so as to increase the moisture content, or by enhancing the dispersiveness of the components in the slurry composition (for example, by increasing the content in the kneaded mixture of the water soluble resin including a monomeric unit containing an acidic functional group).

### <<Production of Composite Particles>>

In the method for production of composite particles for a positive electrode according to the present invention, the slurry composition obtained in the slurry preparation step is spray dried to produce composite particles (granulation step). Since the moisture content of the slurry composition is at most 25% by mass, the amount of time required to produce the composite particles by spray drying the slurry composition in the granulation step can be shortened. Furthermore, the granular binder resin and water are added to the kneaded mixture of the positive electrode active material, the conductive material, and the water soluble resin including a monomeric unit containing an acidic functional group, and the viscosity of the slurry composition at a shear velocity of 10 s⁻¹ is set to be at most 2000 mPa·s, thus allowing for the efficient production of composite particles with good electrical characteristics.

The average particle size of the resulting composite particles for a positive electrode is preferably at least 30 μm and preferably at most 200 μm, more preferably being at most 100 μm. Setting the average particle size of the composite particles for a positive electrode to be at least 30 μm prevents decomposition of the electrolysis solution due to the specific surface area of the composite particles becoming too large, and setting the size to be at most 200 μm improves the filling fraction of the composite particles per unit volume when used for production of a positive electrode, thus yielding sufficient battery capacity. Note that the 50% volume average particle size is used as the average particle size of the composite particles.

The composite particles for a positive electrode according to the present invention have a structure such that in one particle, the positive electrode active material and the conductive material are bonded via the granular binder resin, and the water soluble resin including a monomeric unit containing an acidic functional group exists between or around the positive electrode active material, the conductive material, and the granular binder resin. When the positive electrode active material is coated by the coating material, portions of the coated positive electrode active material are bound to each other by the granular binder resin, or the coated positive electrode active material and the conductive material not included in the coating material layer of the coated positive electrode active material are bound by the granular binder resin. Additionally, the water soluble resin including the monomeric unit containing an acidic functional group exists between or around the coated positive electrode active material, the conductive material, and the granular binder resin.

Therefore, in the composite particles for a positive electrode, the conductive material can form a continuous structure, thereby forming a conductive path so as to lower resistance. Furthermore, even when using a Ni containing positive electrode active material as the positive electrode active material, alkaline corrosive material that is eluted from the positive electrode active material can be neutralized by protons (H⁺) derived from the acidic functional group in the water soluble resin including a monomeric unit containing an acidic functional group. Moreover, when the coated positive electrode active material is used, the coating material layer also suppresses elution of the corrosive material from the Ni containing positive electrode active material.

### EXAMPLES

The following describes the present invention in detail based on examples, yet the present invention is not limited to these examples. In the following, “parts” and “%” are used to indicate amounts based on mass unless otherwise indicated. Furthermore, unless otherwise indicated, the operations described below were performed at ordinary temperature and pressure.

Characteristics were assessed with the following methods. Table 1 shows the assessment results.

### <Viscosity of Slurry Composition>

The viscosity of the produced slurry was measured at a temperature of 25° C. and a shear velocity of 10 s⁻¹, using a double cylinder rotary viscometer.

### <Productivity of Composite Particles for a Positive Electrode>

The productivity when producing composite particles for a positive electrode was assessed by the following standard. Specifically, the productivity was assessed with the following standard based on both the time required to produce the composite particles for a positive electrode and the electrical characteristics (referred to below as “rate characteristics”) of a laminated cell produced using the resulting composite particles for a positive electrode.

A: Short time required for production, and rate characteristics assessed as A

B: Short time required for production, and rate characteristics assessed as B

C: Intermediate time required for production, and rate characteristics assessed as A or B

D: Long time required for production, and/or rate characteristics assessed as C or D

### <Rate Characteristics>

Using the produced laminated cells, a charge-discharge cycle at 25° C. to charge to 4.2 Vat a constant current of 0.1 C and then to discharge to 3.0 Vat a constant current of 0.1 C, and a charge-discharge cycle at 25° C. to charge to 4.2 V at a constant current of 0.1 C and then to discharge to 3.0 V at a constant current of 2.0 C were performed. The ratio of the discharge capacity at 2.0 C to the battery capacity at 0.1 C was calculated as a percentage and used to assess the charge-discharge rate characteristics.

Note that the battery capacity at 0.1 C refers to the discharge capacity at the time of discharge to 3.0 V at a constant current of 0.1 C, whereas the discharge capacity at 2.0 C refers to the discharge capacity at the time of discharge to 3.0 V at a constant current of 2.0 C.

The charge-discharge rate characteristics were assessed on the following scale. A larger value for the charge-discharge rate characteristics indicates smaller, internal resistance and the capability of high-speed charge and discharge.

A: charge-discharge rate characteristics of at least 75%

B: charge-discharge rate characteristics of at least 70% and less than 75%

C: charge-discharge rate characteristics of at least 65% and less than 70%

D: charge-discharge rate characteristics of less than 65%

### <Low Temperature Output Characteristics>

The produced laminated cells were charged at 25° C. to a State Of Charge (SOC) of 50% at a constant current of 0.1 C, and a voltage V0 was measured. Subsequently, the cells were discharged at −10° C. for 10 seconds at a constant current of 1.0 C, and a voltage V1 was measured. Based on these measurements results, a voltage drop ΔV=V0−V1 was calculated.

The calculated voltage drop ΔV was assessed on the following scale. A smaller value for the voltage drop ΔV indicates better low temperature output characteristics.

A: voltage drop ΔV of at least 120 mV and less than 140 mV

B: voltage drop ΔV of at least 140 mV and less than 160 mV

C: voltage drop ΔV of at least 160 mV and less than 180 mV

D: voltage drop ΔV of at least 180 mV

Water soluble resins 1 to 3 including a monomeric unit containing an acidic functional group and granular binder resins 1 and 2 were produced as follows.

### <Production of Water Soluble Resin 1 Including a Monomeric Unit Containing an Acidic Functional Group>

Into a 1 L SUS separable flask provided with an agitator, a reflux cooling tube, and a thermometer, 32.5 parts of methacrylic acid as a monomer containing an acidic functional group, 0.8 parts of ethylene dimethacrylate as a crosslinkable monomer, 7.5 parts of 2,2,2-trifluoroethyl methacrylate as a fluorine-containing (meth)acrylic acid ester monomer, 58.0 parts of butyl acrylate as a (meth)acrylic acid ester monomer, 1.2 parts of polyoxyalkylene alkenyl ether ammonium sulfate (“LATEMUL PD-104” manufactured by Kao Corporation) in terms of solid content as a reactive surfactant monomer, 0.6 parts of t-dodecyl mercaptan, 150 parts of deionized water, and 0.5 parts of potassium persulfate as a polymerization initiator were added. The mixture was agitated thoroughly and then heated to 60° C. to begin polymerization. When the polymer conversion rate reached 96%, the mixture was cooled to stop the reaction, yielding a mixture including the water soluble resin 1 containing an acidic functional group.

10% ammonia water was added to the mixture including the water soluble resin 1 containing an acidic functional group (the amount of ammonia being 1.5 parts per 100 parts of the water soluble resin 1 containing an acidic functional group) to adjust to pH 8, yielding an aqueous solution including the water soluble resin 1 containing an acidic functional group.

### <Production of Water Soluble Resin 2 Including a Monomeric Unit Containing an Acidic Functional Group>

Into a 1 L SUS separable flask provided with an agitator, a reflux cooling tube, and a thermometer, 20 parts of diphenyl-2-methacryloyloxyethyl phosphate as a monomer containing an acidic functional group, 2.5 parts of 2,2,2-trifluoromethyl methacrylate as a fluorine-containing (meth)acrylic acid ester monomer, 77.5 parts of butyl acrylate as a (meth)acrylic acid ester monomer, 1.0 part of sodium dodecylbenzenesulfonate as an emulsifier, 150 parts of deionized water, and 0.5 parts of potassium persulfate as a polymerization initiator were added. The mixture was agitated thoroughly and then heated to 60° C. to begin polymerization. When the polymer conversion rate reached 96%, the mixture was cooled to stop the reaction, yielding a mixture including the water soluble resin 2 containing an acidic functional group.

10% ammonia water was added to the mixture including the water soluble resin 2 containing an acidic functional group (the amount of ammonia being 1.5 parts per 100 parts of the water soluble resin 2 containing an acidic functional group) to adjust to pH 8, yielding an aqueous solution including the water soluble resin 2 containing an acidic functional group.

### <Production of Water Soluble Resin 3 Including a Monomeric Unit Containing an Acidic Functional Group>

Into a 1 L SUS separable flask provided with an agitator, a reflux cooling tube, and a thermometer, desalinated water was injected in advance, thoroughly agitated, and subsequently heated to 70° C. Then, 0.2 parts of potassium persulfate aqueous solution were added.

Into a separate 5 MPa pressure tight container with an agitator, a mixture including 30 parts of methacrylic acid and 2.5 parts of 2-acrylamide-2-methylpropane sulfonic acid (AMPS) as a monomer containing an acidic functional group, 35 parts of ethyl acrylate and 32.5 parts of butyl acrylate as monomers of (meth)acrylic acid ester, 0.115 parts in terms of solid content of a 30% concentration of sodium dodecyldiphenylethersulfonate as an emulsifier, 50 parts of deionized water, and 0.4 parts of sodium hydrogen carbonate was injected and thoroughly stirred to produce an aqueous emulsion.

The resulting aqueous emulsion was continuously dripped into the above separable flask for 4 hours. When the polymer conversion rate reached 90%, the reaction temperature was set to 80° C., and after reacting for 2 more hours, the mixture was cooled to stop the reaction when the polymer conversion rate reached 99%, yielding a mixture including the water soluble resin 3 containing an acidic functional group.

10% ammonia water was added to the mixture including the water soluble resin 3 containing an acidic functional group (the amount of ammonia being 1.5 parts per 100 parts of the water soluble resin 3 containing an acidic functional group) to adjust to pH 8, yielding an aqueous solution including the water soluble resin 3 containing an acidic functional group.

### <Production of Granular Binder Resin 1>

Into a 1 L SUS separable flask provided with an agitator, a reflux cooling tube, and a thermometer, 130 parts of deionized water were added, and then 0.8 parts of ammonium persulfate as a polymerization initiator and 10 parts of deionized water were further added. The resultant was heated to 80° C.

In a separate container with an agitator, 76 parts of 2-ethylhexyl acrylate as a monomer of (meth)acrylic acid ester, 20 parts of acrylonitrile as an α,β-unsaturated nitrile monomer, 4.0 parts of itaconic acid as a monomer containing an acidic functional group, 2.0 parts of sodium dodecylbenzenesulfonate as an emulsifier, and 377 parts of deionized water were added and thoroughly stirred to prepare an emulsion.

The resulting emulsion was continuously added to the separable flask for three hours. After 2 hours of further reaction, the resultant was cooled to stop the reaction. 10% ammonia water was then added to adjust to pH 7.5, yielding an aqueous dispersion of the granular binder resin 1. The polymer conversion rate was 98%. The glass transition temperature of the resulting granular binder resin 1 was −30° C., and the volume average particle size was 150 nm.

### <Production of Granular Binder Resin 2>

An aqueous dispersion of the granular binder resin 2 was obtained similarly to the granular binder resin 1, differing in that 78 parts of 2-ethylhexyl acrylate were used, and 2.0 parts of methacrylic acid were used instead of 4.0 parts of itaconic acid. The polymer conversion rate was 98%. The glass transition temperature of the resulting granular binder resin 2 was −40° C., and the volume average particle size was 200 nm.

### Example 1

The slurry composition, composite particles, and secondary battery of Example 1 were produced with the following steps.

### (a) Production of Slurry Composition

The concentration of the aqueous dispersion of the granular binder resin 1 obtained as above was adjusted to yield a 40% aqueous dispersion.

100 parts of a Li₂MnO₃—LiNiO₂ based solid solution positive electrode active material, 4.0 parts of acetylene black (“HS-100” manufactured by Denki Kagaku Kogyo Kabushiki Kaisha), 2.0 parts in terms of solid content of an aqueous solution including the water soluble resin 1 containing an acidic functional group, and 2.0 parts in terms of solid content of a 1% aqueous solution of carboxymethyl cellulose (“BSH-6” manufactured by Dai-Ichi Kogyo Seiyaku Co., Ltd.) were added to a planetary mixer equipped with a disperser. The overall solid content concentration was adjusted to 85% (moisture content of 15%) with deionized water, yielding a mixture. The resulting mixture was kneaded with a planetary mixer at a temperature of 25° C. for 60 minutes, with a circumferential speed of 0.8 m/s as the agitation rate. The energy applied to the mixture was 120 MJ/m³. Next, 2.0 parts in terms of solid content of a 40% aqueous dispersion of the granular binder resin 1 were added, and the overall solid content concentration was adjusted to 75% (moisture content of 25%) with deionized water. The resultant was mixed to obtain a slurry composition. The viscosity of the obtained slurry composition as measured with the above method was 880 mPa·s (in Table 1, this slurry composition production method is listed as “α”).

### (b) Production of Composite Particles for a Positive Electrode

The slurry composition obtained as above was fed to a spray dryer (“OC-16” manufactured by Ohkawara Kakohki Co., Ltd.) and spray dried using a rotating disk atomizer (65 mm diameter) under the following conditions to yield composite particles 1 for a positive electrode: rotation speed of 25000 rpm, hot air temperature of 150° C., and particle recovery outlet temperature of 90° C. The volume average particle size was 67 μm.

### (c) Production of Positive Electrode

The composite particles 1 for a positive electrode obtained as above were fed to pressure rollers (roll temperature: 100° C., press line pressure: 500 kN/m) of a roll presser (“Pushing cut rough-surface heat roll” manufactured by Hirano Gikenkogyo Co., Ltd.) using a volumetric feeder (“Nikka K-V spray” manufactured by Nikka Ltd.). A 20 μm thick aluminum foil was inserted between the pressure rollers, and the composite particles 1 for a positive electrode fed from the volumetric feeder were adhered to the aluminum foil (collector). Pressure formation at a formation rate of 1.5 m/min yielded a positive electrode having positive electrode active material layer.

### (d) Production of Negative Electrode Slurry Composition

100 parts of artificial graphite with a specific surface area of 4 m²/g as negative electrode active material (average particle size: 24.5 μm) and 1 part in terms of solid content of a 1% aqueous solution of carboxymethyl cellulose (“BSH-12” manufactured by Dai-Ichi Kogyo Seiyaku Co., Ltd.) as a dispersant were added to a planetary mixer equipped with a disperser. The overall solid content concentration was adjusted to 52% with deionized water, and the resultant was agitated to obtain a mixed liquid.

To the mixed liquid, 1.0 part in terms of solid content of a 40% aqueous dispersion including a styrene-butadiene copolymer (glass transition temperature: −15° C.) was added. The overall solid content concentration was adjusted to 50% by adding deionized water to the mixture. The mixture was defoamed under reduced pressure to yield a negative electrode slurry composition.

### (e) Production of Negative Electrode

The negative electrode slurry composition obtained as above was applied to a 20 μm thick copper foil using a comma coater and dried so that the thickness after drying was approximately 150 μm. The drying was performed by transporting the copper foil at a speed of 0.5 m/min through an oven at 60° C. for 2 minutes. Subsequently, the copper foil was heated for 2 minutes at 120° C. to yield a negative electrode sheet. The negative electrode sheet was then rolled in a roll press to obtain a negative electrode having a negative electrode active material layer.

### (f) Preparation of Separator

A single-layer polypropylene separator (width 65 mm, length 500 mm, thickness 25 μm, produced by a dry method, porosity 55%) was cut out as a 5 cm×5 cm square.

### (g) Production of Lithium Ion Secondary Battery

An aluminum packing case was prepared as the casing of the battery. The positive electrode obtained as above was cut into a 4 cm×4 cm square and disposed so that the front face, i.e. the collector side, was in contact with the aluminum packing case. The square separator obtained as above was disposed on the surface of the positive electrode active material layer. Next, the negative electrode obtained as above was cut into a 4.2 cm×4.2 cm square and disposed on the separator so that the front face, i.e. the negative electrode active material layer side, is faced the separator. The aluminum packing was then filled with a 1.0 M concentration LiPF₆ solution containing 2.0% of vinylene carbonate. The solvent for the LiPF₆ solution was a mixed solvent of ethylene carbonate (EC) and ethyl methyl carbonate (EMC) (EC/EMC=3/7 (volume ratio)). Furthermore, in order to tightly seal the opening of the aluminum packing, the aluminum case was closed by heat sealing at 150° C. to produce a laminated lithium ion secondary battery (laminated cell).

The rate characteristics and low temperature output characteristics of this laminated cell were assessed.

### Example 2

A slurry composition (viscosity: 940 mPa·s) and composite particles for a positive electrode (volume average particle size: 65 μm) were produced similarly to those of Example 1, differing in that LiCoO₂ was used instead of a Li₂MnO₃—LiNiO₂ based solid solution positive electrode active material. A laminated lithium ion secondary battery was then produced.

### Example 3

A slurry composition (viscosity: 1050 mPa·s) and composite particles for a positive electrode (volume average particle size: 72 μm) were produced similarly to those of Example 1, differing in that an aqueous solution including the water soluble resin 2 containing an acidic functional group was used instead of the aqueous solution including the water soluble resin 1 containing an acidic functional group. A laminated lithium ion secondary battery was then produced.

### Example 4

A slurry composition (viscosity: 1200 mPa·s) and composite particles for a positive electrode (volume average particle size: 63 μm) were produced similarly to those of Example 1, differing in that an aqueous solution including the water soluble resin 3 containing an acidic functional group was used instead of the aqueous solution including the water soluble resin 1 containing an acidic functional group. A laminated lithium ion secondary battery was then produced.

### Example 5

A slurry composition (viscosity: 650 mPa·s) and composite particles for a positive electrode (volume average particle size: 65 μm) were produced similarly to those of Example 1, differing in that the amount of the aqueous solution including the water soluble resin 1 containing an acidic functional group was 5.0 parts in terms of solid content, and in that the 1% aqueous solution of carboxymethyl cellulose was not added. A laminated lithium ion secondary battery was then produced.

### Example 6

A slurry composition (viscosity: 720 mPa·s) and composite particles for a positive electrode (volume average particle size: 68 μm) were produced similarly to those of Example 1, differing in that the amount of the aqueous solution including the water soluble resin 1 containing an acidic functional group was 3.0 parts in terms of solid content, and in that the amount of the 1% aqueous solution of carboxymethyl cellulose was 1.0 part in terms of solid content. A laminated lithium ion secondary battery was then produced.

### Example 7

A slurry composition (viscosity: 1150 mPa·s) and composite particles for a positive electrode (volume average particle size: 71 μm) were produced similarly to those of Example 1, differing in that the amount of the aqueous solution including the water soluble resin 1 containing an acidic functional group was 1.0 parts in terms of solid content, and in that the amount of the 1% aqueous solution of carboxymethyl cellulose was 3.0 parts in terms of solid content. A laminated lithium ion secondary battery was then produced.

### Example 8

A slurry composition (viscosity: 930 mPa·s) and composite particles for a positive electrode (volume average particle size: 63 μm) were produced similarly to those of Example 1, differing in that a 40% aqueous dispersion of the granular binder resin 2 was used instead of a 40% aqueous dispersion of the granular binder resin 1. A laminated lithium ion secondary battery was then produced.

### Example 9

A slurry composition (viscosity: 1500 mPa·s) and composite particles for a positive electrode (volume average particle size: 65 μm) were produced similarly to those of Example 1, differing in that when preparing the slurry composition, the overall solid content concentration was adjusted to 77% (moisture content of 23%) with deionized water. A laminated lithium ion secondary battery was then produced.

### Example 10

A slurry composition (viscosity: 1900 mPa·s) and composite particles for a positive electrode (volume average particle size: 63 μm) were produced similarly to those of Example 1, differing in that when preparing the slurry composition, the overall solid content concentration was adjusted to 79% (moisture content of 21%) with deionized water. A laminated lithium ion secondary battery was then produced.

### Example 11

A slurry composition (viscosity: 1200 mPa·s) and composite particles for a positive electrode (volume average particle size: 65 μm) were produced similarly to those of Example 1, differing in that the agitation rate when kneading the mixture was a circumferential speed of 0.6 m/s, and the energy applied to the mixture was 90 MJ/m³. A laminated lithium ion secondary battery was then produced.

### Comparative Example 1

A slurry composition (viscosity: 2400 mPa·s) and composite particles for a positive electrode (volume average particle size: 78 μm) were produced similarly to those of Example 1, differing in that the aqueous solution including the water soluble resin 1 containing an acidic functional group was not used, and in that the amount of the 1% aqueous solution of carboxymethyl cellulose was 3.0 parts in terms of solid content. A laminated lithium ion secondary battery was then produced.

### Comparative Example 2

A slurry composition (viscosity: 520 mPa·s) and composite particles for a positive electrode (volume average particle size: 61 μm) were produced similarly to those of Example 1, differing in that when preparing the slurry composition, the overall solid content concentration was adjusted to 60% (moisture content of 40%) with deionized water. A laminated lithium ion secondary battery was then produced.

### Comparative Example 3

A slurry composition (viscosity: 3550 mPa·s) and composite particles for a positive electrode (volume average particle size: 75 μm) were produced similarly to those of Example 1, differing as follows: when preparing the mixture, the overall solid content concentration was adjusted to 75% (moisture content of 25%) with deionized water; when preparing the slurry composition, the overall solid content concentration was adjusted to 73% (moisture content of 27%) with deionized water; and when kneading the mixture, an energy of 15 MJ/m³ was applied. A laminated lithium ion secondary battery was then produced.

### Comparative Example 4

A slurry composition (viscosity: 3700 mPa·s) and composite particles for a positive electrode (volume average particle size: 69 μm) were produced similarly to those of Example 1, differing in that the slurry composition was obtained as follows: 100 parts of a Li₂MnO₃—LiNiO₂ based solid solution positive electrode active material, 4.0 parts of acetylene black (“HS-100” manufactured by Denki Kagaku Kogyo Kabushiki Kaisha), 2.0 parts in terms of solid content of an aqueous solution including the water soluble resin 1 containing an acidic functional group, 2.0 parts in terms of solid content of a 1% aqueous solution of carboxymethyl cellulose (“BSH-6” manufactured by Dai-Ichi Kogyo Seiyaku Co., Ltd.), and 2.0 parts in terms of solid content of a 40% aqueous dispersion of the granular binder resin 1 were added to a planetary mixer equipped with a disperser; the overall solid content concentration was adjusted to 75% (moisture content of 25%) with deionized water, and the resultant was mixed. A laminated lithium ion secondary battery was then produced (in Table 1, this slurry composition production method is listed as “β”).

### Comparative Example 5

A slurry composition (viscosity: 6100 mPa·s) and composite particles for a positive electrode (volume average particle size: 61 μm) were produced similarly to those of Example 1, differing in that when preparing the slurry composition, the overall solid content concentration was adjusted to 82% (moisture content of 18%) with deionized water. A laminated lithium ion secondary battery was then produced.

TABLE 1

| | | | Exam- | Exam- | Exam- | Exam- | Exam- | Exam- | Exam- | Exam- | |
|---|---|---|---|---|---|---|---|---|---|---|---|
| | | | ple 1 | ple 2 | ple 3 | ple 4 | ple 5 | ple 6 | ple 7 | ple 8 | Example 9 |
| Formulation | Positive electrode active | Li₂MnO₃—LiNiO₂ | 100 | 0 | 100 | 100 | 100 | 100 | 100 | 100 | 100 |
| and other | material (parts by mass) | based solid solution | | | | | | | | | |
| properties of | | LiCoO₂ | 0 | 100 | 0 | 0 | 0 | 0 | 0 | 0 | 0 |
| slurry | Water soluble resin | resin 1 | 2 | 2 | 0 | 0 | 5 | 3 | 1 | 2 | 2 |
| composition | including a monomeric | resin 2 | 0 | 0 | 2 | 0 | 0 | 0 | 0 | 0 | 0 |
| | unit containing an | resin 3 | 0 | 0 | 0 | 2 | 0 | 0 | 0 | 0 | 0 |
| | acidic functional group | | | | | | | | | | |
| | (parts by mass) | | | | | | | | | | |
| | Conductive material | acetylene black | 4 | 4 | 4 | 4 | 4 | 4 | 4 | 4 | 4 |
| | (parts by mass) | | | | | | | | | | |
| | Granular binder resin | resin 1 | 2 | 2 | 2 | 2 | 2 | 2 | 2 | 0 | 2 |
| | (parts by mass) | resin 2 | 0 | 0 | 0 | 0 | 0 | 0 | 0 | 2 | 0 |
| | Carboxymethyl cellulose (parts by mass) | | 2 | 2 | 2 | 2 | 0 | 1 | 3 | 2 | 2 |
| | Moisture content of mixture (% by mass) | | 15 | 15 | 15 | 15 | 15 | 15 | 15 | 15 | 15 |
| | Moisture content of slurry composition | | 25 | 25 | 25 | 25 | 25 | 25 | 25 | 25 | 23 |
| | (% by mass) | | | | | | | | | | |
| | Viscosity (mPa · s) at shear velocity of 10 s⁻¹ | | 880 | 940 | 1050 | 1200 | 650 | 720 | 1150 | 930 | 1500 |
| | Kneading conditions | circumferential | 0.8 | 0.8 | 0.8 | 0.8 | 0.8 | 0.8 | 0.8 | 0.8 | 0.8 |
| | | speed (m/s) | | | | | | | | | |
| | | applied energy | 120 | 120 | 120 | 120 | 120 | 120 | 120 | 120 | 120 |
| | | (MJ/m³) | | | | | | | | | |

| Slurry composition production method | | α | α | α | α | α | α | α | α | α |
|---|---|---|---|---|---|---|---|---|---|---|
| Assessment | Productivity | A | A | A | B | B | A | A | B | A |
| results | Rate characteristics | A | A | A | B | B | A | A | B | A |
| | Low temperature output characteristics | A | B | A | A | B | A | A | A | B |

| | | | | | | | | | Com- |
|---|---|---|---|---|---|---|---|---|---|
| | | | Exam- | Exam- | Comparative | Comparative | Comparative | Comparative | parative |
| | | | ple 10 | ple 11 | Example 1 | Example 2 | Example 3 | Example 4 | Example 5 |
| Formulation | Positive electrode active | Li₂MnO₃—LiNiO₂ | 100 | 100 | 100 | 100 | 100 | 100 | 100 |
| and other | material (parts by mass) | based solid solution | | | | | | | |
| properties of | | LiCoO₂ | 0 | 0 | 0 | 0 | 0 | 0 | 0 |
| slurry | Water soluble resin | resin 1 | 2 | 2 | 0 | 2 | 2 | 2 | 2 |
| composition | including a monomeric | resin 2 | 0 | 0 | 0 | 0 | 0 | 0 | 0 |
| | unit containing an | resin 3 | 0 | 0 | 0 | 0 | 0 | 0 | 0 |
| | acidic functional group | | | | | | | | |
| | (parts by mass) | | | | | | | | |
| | Conductive material | acetylene black | 4 | 4 | 4 | 4 | 4 | 4 | 4 |
| | (parts by mass) | | | | | | | | |
| | Granular binder resin | resin 1 | 2 | 2 | 2 | 2 | 2 | 2 | 2 |
| | (parts by mass) | resin 2 | 0 | 0 | 0 | 0 | 0 | 0 | 0 |

| | | | | | | | |
|---|---|---|---|---|---|---|---|
| Carboxymethyl cellulose (parts by mass) | 2 | 2 | 3 | 2 | 2 | 2 | 2 |
| Moisture content of mixture (% by mass) | 15 | 15 | 15 | 15 | 25 | — | 15 |
| Moisture content of slurry composition | 21 | 25 | 25 | 40 | 27 | 25 | 18 |
| (% by mass) | | | | | | | |
| Viscosity (mPa · s) at shear velocity of 10 s⁻¹ | 1900 | 1200 | 2400 | 520 | 3550 | 3700 | 6100 |

| | | | | | | | | |
|---|---|---|---|---|---|---|---|---|
| Kneading conditions | circumferential | 0.8 | 0.6 | 0.8 | 0.8 | 0.8 | — | 0.8 |
| | speed (m/s) | | | | | | | |
| | applied energy | 120 | 90 | 120 | 120 | 15 | — | 120 |
| | (MJ/m³) | | | | | | | |

| Slurry composition production method | | α | α | α | α | α | β | α |
|---|---|---|---|---|---|---|---|---|
| Assessment | Productivity | B | B | D | D | D | D | D |
| results | Rate characteristics | B | B | B | B | C | C | D |
| | Low temperature output characteristics | B | A | C | B | C | C | D |

Table 1 shows that with Examples 1 to 11, composite particles can be produced with higher productivity than with Comparative Example 1, in which the slurry composition does not have a water soluble resin including a monomeric unit containing an acidic functional group, Comparative Example 2, in which the moisture content of the slurry composition is 40% by mass, Comparative Example 3, in which the moisture content of the slurry composition is 27% by mass, Comparative Example 4, in which composite particles are produced in accordance with production method β, and Comparative Example 5, in which the slurry composition has a viscosity at a shear velocity of 10 s⁻¹ of 6100 mPa·s.

In particular, the lithium ion secondary battery having a positive electrode formed using the composite particles of Examples 1, 3, 6, and 7 had both excellent rate characteristics and low temperature output characteristics.

### INDUSTRIAL APPLICABILITY

According to the present invention, it is possible to provide a slurry composition that can yield composite particles for a positive electrode with good electrical characteristics by dry granulation using spray drying even when the solid content concentration is high, as well as a high-productivity method for producing the composite particles for a positive electrode.

1. A slurry composition for composite particles for a positive electrode, the slurry composition comprising:
a positive electrode active material, a conductive material, a water soluble resin including a monomeric unit containing an acidic functional group, and a granular binder resin,
a moisture content being at most 25% by mass, and
a viscosity at a shear velocity of 10 s⁻¹ being at most 2000 mPa·s.

2. The slurry composition for composite particles for a positive electrode according to claim 1, wherein the positive electrode active material is a Li₂MnO₃—LiNiO₂ based solid solution positive electrode active material.

3. The slurry composition for composite particles for a positive electrode according to claim 1, wherein the water soluble resin including a monomeric unit containing an acidic functional group includes at least one selected from the group consisting of a monomeric unit containing a sulfonic acid group, a monomeric unit containing a carboxyl group, and a monomeric unit containing a phosphoric acid group.

4. The slurry composition for composite particles for a positive electrode according to claim 1, wherein the granular binder resin includes a monomeric unit of (meth)acrylic acid ester with a carbon number of 6 to 15, an α,β-unsaturated nitrile monomeric unit, and a monomeric unit containing a carboxyl group.

5. The slurry composition for composite particles for a positive electrode according to claim 1, wherein the granular binder resin includes a monomeric unit of dibasic acid.

6. A method for producing composite particles for a positive electrode, comprising:
kneading a mixture including a positive electrode active material, a conductive material, and a water soluble resin including a monomeric unit containing an acidic functional group to obtain a kneaded mixture;
preparing a slurry composition with a moisture content of at most 25% by mass and a viscosity at a shear velocity of 10 s⁻¹ of at most 2000 mPa·s by adding a granular binder resin and water to the kneaded mixture; and
spray drying the slurry composition to obtain composite particles.

7. The method for producing composite particles for a positive electrode according to claim 6, wherein during the kneading step, the mixture is kneaded by applying an energy of 50 MJ/m³ to 200 MJ/m³.
